(19) United States
(12) Patent Application Publication
(10) Pub. No.: US 2022/0107459 A1
(43) Pub. Date: Apr. 7, 2022

(54) Optical Circuit

(71) Applicant: Nippon Telegraph and Telephone Corporation, Tokyo (JP)

(72) Inventors: Junji Sakamoto, Musashino-shi, Tokyo (JP); Toshikazu Hashimoto, Musashino-shi, Tokyo (JP)

(21) Appl. No.: 17/426,232

(22) PCT Filed: Jan. 24, 2020
(86) PCT No.: PCT/JP2020/002450

§ 371 Date: Jul. 28, 2021

(30) Foreign Application Priority Data
Jan. 29, 2019 (JP) 2019-013035

(51) Int. Cl. G02B 6/12; G02B 6/14

(52) U.S. Cl. CPC G02B 6/12007; G02B 6/12004; G02B 6/14

(57) ABSTRACT

To provide an optical circuit in which the deviation of optical power per wavelength is reduced. An optical multiplexing circuit of the present disclosure includes a transmission light adjustment circuit, which is a loss portion that provides excessive loss in paths of red light and green light so as to have the same power as the output power of blue light. By varying the path length of each color, a path for wavelength with great propagation loss is short and a path for wavelength with a slight loss is long.

### TECHNICAL FIELD

The present disclosure relates to an optical device and, more particularly, to a wavelength multiplexing circuit in an optical circuit.

### BACKGROUND ART

In the field of information processing using light (for example, Non Patent Literature) and in the field of optical communications, filters and switches using waveguides have been developed. For example, in a quartz-based planar lightwave circuit (PLC), a glass film that is an undercladding is deposited on a Si substrate, and a glass film with an adjusted refractive index so as to have a desired refractive index difference (Δ) is deposited on the glass film. The glass film is patterned by photolithography and reactive ion etching to produce a core. Finally, the periphery is embedded with a glass film (overcladding) having a lower refractive index than the core to form a waveguide. PLC is characterized by having a high transmittance in a range from visible to infrared, and various functions are achieved with a low loss by combining a plurality of basic optical circuits (for example, directional couplers, Mach-Zehnder interferometers, and the like). In recent years, research and development that utilize PLC not only in optical communication but also in the visible light field by taking advantage of the feature that the PLC is transparent (low propagation losses) even in visible light is attracting attention. For example, a plurality of RGB couplers that multiplex red (R), green (G), and blue (B), which are three primary colors of light, are reported, and the development in the field of video has been studied.

By using a polymer waveguide rather than a quartz-based waveguide, the cost reduction of the waveguide-type RGB coupler can be expected. The polymer waveguide is produced by spin coating and patterning by using the cladding polymer and core polymer having a refractive index difference adjusted. Examples of a patterning technique that is promising for lower costs include a direct exposure method and a light nanoimprint method. Because the spin-coated core polymer is directly patterned, these methods can simplify the producing process, without dry etching and the like. On the other hand, because patterning is performed using a reaction caused by absorption of UV light, there is a problem that the loss of light on the short wavelength side such as blue is great, and when broadband wavelength is handled as an RGB coupler, the transmittance is biased by the wavelength (color). Actually, for an embedded polymer waveguide, which is made by the present inventors on trial, with SU-8 material as a core and adjusted to have a refractive index difference (Δ) of 0.8%, propagation losses are 0.8 to 4.4 dB/cm for light with wavelength 465 to 638 nm.

### CITATION LIST

### Non Patent Literature

[Non Patent Literature 1] A. Nakao, et al., “Integrated waveguide-type red-green-blue beam combiners for compact projection-type displays”, Optics Communications 330 (2014) 45-48

### SUMMARY OF THE INVENTION

### Technical Problem

When an RGB coupler is produced using a polymer waveguide, the propagation losses differ depending on the wavelength (color), and therefore, even when the transmittance of the multiplexing portion is approximately equivalent, there is a problem that the output is biased.

### Means for Solving the Problem

A circuit for transmittance adjustment is formed in each of a green waveguide and a red waveguide, for example, based on a blue waveguide having maximum propagation losses.

An optical circuit of the present disclosure for solving the above problems includes a semiconductor substrate, a multiplexing circuit on the semiconductor substrate, a first waveguide including a polymer, which is connected, on the semiconductor substrate, to the multiplexing circuit and propagates red light, a second waveguide including the polymer, which is connected, on the semiconductor substrate, to the multiplexing circuit and propagates green light, a third waveguide including the polymer, which is connected, on the semiconductor substrate, to the multiplexing circuit and propagates blue light, and an output waveguide connected, on the semiconductor substrate, to the multiplexing circuit and located opposite to the first waveguide, the second waveguide, and the third waveguide, in which each of the first waveguide and the second waveguide is provided with a loss portion (an adjustment circuit of transmitted light) that causes an excessive loss so that the power of each of the first waveguide and the second waveguide becomes the same as the output power of the third waveguide.

### Effects of the Invention

According to the present disclosure, a polymer waveguide type RGB coupler having different propagation losses depending on the wavelength (color) has an effect that the output can be balanced.

### BRIEF DESCRIPTION OF DRAWINGS

FIG. 1 is a diagram illustrating a cross-sectional structure of a waveguide according to Embodiment 1.

FIG. 2 is a diagram illustrating an optical circuit according to Embodiment 1 of the present disclosure.

FIG. 3 is a diagram illustrating a configuration of an optical circuit according to Embodiment 2 of the present disclosure.

FIG. 4 is a diagram illustrating a configuration of the optical circuit according to Embodiment 2 of the present disclosure.

### DESCRIPTION OF EMBODIMENTS

Hereinafter, embodiments of the present disclosure will be described in detail with reference to the drawings. Note that, in the drawings, components with the same function are denoted with the same reference signs for the sake of clear description. However, it is obvious to those skilled in the art that the present disclosure is not limited to the description of the embodiments described below, and the mode and the detail thereof can be modified in various ways without departing from the spirit of the disclosure in this specification and the like. Further, configurations according to different embodiments can be implemented appropriately in combination.

### Embodiment 1

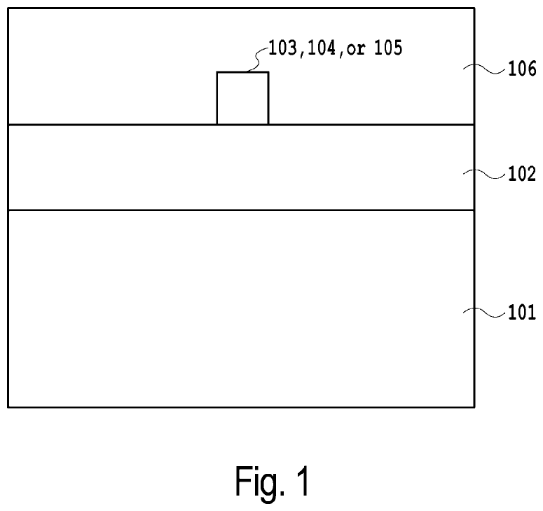

A method of producing a waveguide of the present embodiment will be described briefly. A cross-sectional structure of the waveguide is illustrated in FIG. 1. A SiO₂ film 102 is formed on a semiconductor substrate 101 containing Si, by using a flame hydrolysis deposition (FHD) method. Next, a polymer that is the material of a core is spin-coated. At this time, a material with a higher refractive index than the SiO₂ is selected as the material of the core. Specifically, examples of photocurable resins include SU-8 (manufactured by MicroChem Corp.) and CELVENUS (manufactured by Daicel Corporation), and examples of thermosetting resins include Polymethyl methacrylate (PMMA). Here, a producing method in a case where a photocurable resin that is easily manufactured is used will be described. The material of the spin-coated core is patterned by using photolithography, UV-nano imprint lithography (NIL), or the like, and finally the core is embedded with the cladding polymer 106. The cladding material is selected to have a lower refractive index than the material of the core. When the polymer waveguide produced in this manner is used in the visible light region, because of scattering due to roughness of the core shape and absorption of the material, the shorter the wavelength, the greater the propagation losses become. The core portion corresponds to a first waveguide 103, a second waveguide 104, and a third waveguide 105, described below.

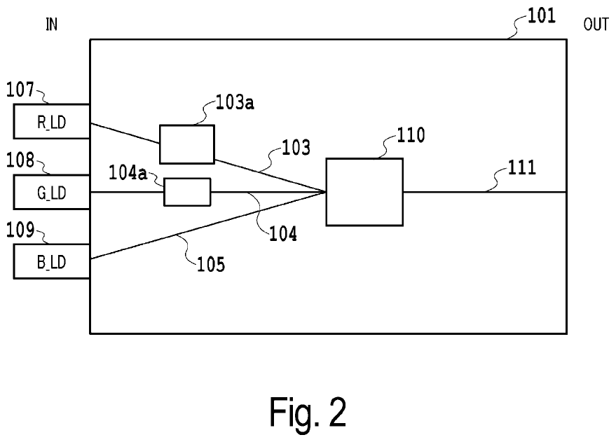

FIG. 2 illustrates an optical circuit including a semiconductor substrate 101, a multiplexing circuit 110 on the semiconductor substrate, a first waveguide 103 including a polymer, which is connected, on the semiconductor substrate, to the multiplexing circuit 110 and propagates red light, a second waveguide 104 including a polymer, which is connected, on the semiconductor substrate, to the multiplexing circuit and propagates green light, a third waveguide 105 including a polymer, which is connected, on the semiconductor substrate, to the multiplexing circuit and propagates blue light, and an output waveguide 111 connected, on the semiconductor substrate, to the multiplexing circuit and located opposite to the first waveguide, the second waveguide, and the third waveguide, in which each of the first waveguide 103 and the second waveguide 104 is provided with a loss portion that causes an excessive loss. The path length of the transmittance adjustment circuit, which is the loss portion, is increased.

Assuming that propagation losses for wavelengths of red light (R), green light (G), and blue light (B) respectively emitted from the first light source 107, the second light source 108, and the third light source 109 are Rₗₒₛₛ (dB/cm), Gₗₒₛₛ (dB/cm), and Bₗₒₛₛ (dB/cm), respectively, the transmittances of the multiplexing circuit 110 for wavelengths of red light (R), green light (G), and blue light (B) respectively emitted from the first light source 107, the second light source 108, and the third light source 109 are R_{couple} (dB), G_{couple} (dB), B_{couple} (dB), respectively, and the path lengths for wavelengths of red light (R), green light (G), and blue light (B) respectively emitted from the first light source 107, the second light source 108, and the third light source 109 are L_{R} (cm), L_{G} (cm), and L_{B} (cm), respectively, the total transmittances Rtrans, Gtrans, and Btrans of wavelengths of the RGB coupler are calculated as follows.

Rₜᵣₐₙₛ: R_{couple}−Rₗₒₛₛ×L_{R}

Gₜᵣₐₙₛ: G_{couple}−Gₗₒₛₛ×L_{G}

Bₜᵣₐₙₛ: B_{couple}−Bₗₒₛₛ×L_{B}

When the transmittances of wavelengths RGB in the multiplexing circuit is made equal (R_{couple}=G_{couple}=B_{couple}), because Rₗₒₛₛ<Gₗₒₛₛ<Bₗₒₛₛ, the output varies depending on the color. In the present embodiment, as illustrated in FIG. 2, transmittance adjustment circuits 103a and 104a are respectively provided in the first waveguide 103 and the second waveguide 104 such that the total transmittances of respective wavelengths are equal before multiplexing. Specifically, the path lengths L_{R} and L_{G} of R and G, respectively, are increased so as to satisfy Rₗₒₛₛ×L_{R}=Gₗₒₛₛ×L_{G}=Bₗₒₛₛ×L_{B}.

This results in RGB light with no output variation from the output waveguide 111. In the present embodiment, by increasing the path for R and G, the light of color input from each of the first waveguide 103, the second waveguide 104, and the third waveguide 105 can be adjusted to have the same output power from the output waveguide 111.

### Embodiment 2

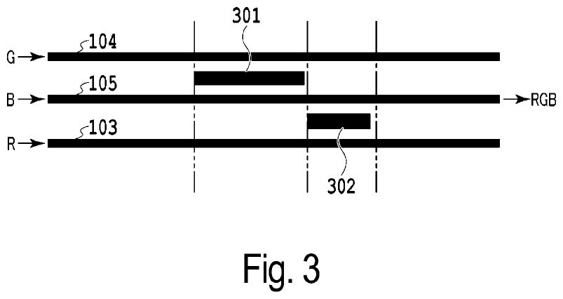

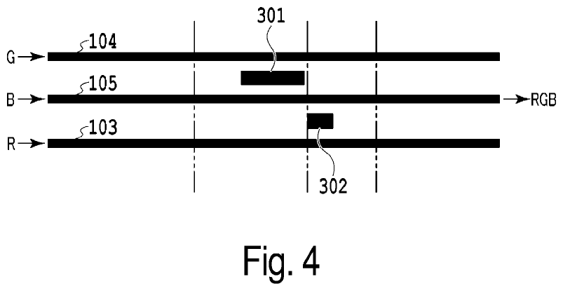

In the present embodiment, by adjusting the wave multiplexing efficiency of the multiplexing circuit, RGB output variation is eliminated. As an example, an adjustment method by using a mode coupler in a multiplexing circuit will be described. The mode coupler is configured as illustrated in FIG. 3, and is a circuit that additionally multiplexes green in the mode converter 301 and red in the mode converter 302. As illustrated in FIG. 4, each of the mode converters is shortened to adjust the transmittance R_{couple} of red light (R) and the transmittance G_{couple} of green light (G) so as to satisfy R_{couple}+Rₗₒₛₛ×L_{R}=G_{couple}+Gₗₒₛₛ×L_{G}=B_{couple}+Bₗₒₛₛ×L_{B}.

This configuration not only achieves RGB light with no output variation, but also eliminates the need for extra circuits and allows the elements to be miniaturized.

### INDUSTRIAL APPLICABILITY

The present disclosure relates to an optical device, and more particularly, can be applied to a wavelength multiplexing circuit in an optical circuit.

### REFERENCE SIGNS LIST

101 Semiconductor substrate
102 SiO₂ film
103 First waveguide
103a Adjustment circuit
104 Second waveguide
104a Adjustment circuit
105 Third waveguide
106 Cladding polymer
107 First light source
108 Second light source
109 Third light source
110 Multiplexing circuit
111 Output waveguide

1. An optical circuit comprising:
a semiconductor substrate;
a multiplexing circuit on the semiconductor substrate;
a first waveguide including a polymer, the first waveguide being connected, on the semiconductor substrate, to the multiplexing circuit and propagating red light (R);
a second waveguide including the polymer, the second waveguide being connected, on the semiconductor substrate, to the multiplexing circuit and propagating green light (G);
a third waveguide including the polymer, the third waveguide being connected, on the semiconductor substrate, to the multiplexing circuit and propagating blue light (B); and
an output waveguide connected, on the semiconductor substrate, to the multiplexing circuit and located opposite to the first waveguide, the second waveguide, and the third waveguide,
wherein each of the first waveguide and the second waveguide is provided with a loss portion that causes an excessive loss.

2. An optical circuit comprising:
a semiconductor substrate;
a multiplexing circuit on the semiconductor substrate;
a first waveguide including a polymer, the first waveguide being connected, on the semiconductor substrate, to the multiplexing circuit and propagating red light (R);
a second waveguide including the polymer, the second waveguide being connected, on the semiconductor substrate, to the multiplexing circuit and propagating green light (G);
a third waveguide including the polymer, the third waveguide being connected, on the semiconductor substrate, to the multiplexing circuit and propagating blue light (B); and
an output waveguide connected, on the semiconductor substrate, to the multiplexing circuit and located opposite to the first waveguide, the second waveguide, and the third waveguide,
wherein assuming that a propagation loss at a wavelength of the red light (R), a propagation loss at a wavelength of the green light (G), and a propagation loss at a wavelength of the blue light (B) are defined as Rₗₒₛₛ, Gₗₒₛₛ, and Bₗₒₛₛ, respectively, and
a path length for the wavelength of the red light (R), a path length for the wavelength of the green light (G), and a path length for the wavelength of the blue light (B) are defined as L_{R} (cm), L_{G} (cm), and L_{B} (cm), respectively,
the path length L_{R} of the first waveguide and the path length L_{G} of the second waveguide are set to be longer than the path length L_{B} of the third waveguide to satisfy a relational expression of Rₗₒₛₛ×L_{R}=Gₗₒₛₛ×L_{G}=Bₗₒₛₛ×L_{B}.

3. An optical circuit comprising:
a semiconductor substrate;
a multiplexing circuit on the semiconductor substrate;
a first waveguide including a polymer, the first waveguide being connected, on the semiconductor substrate, to the multiplexing circuit and propagating red light (R);
a second waveguide including the polymer, the second waveguide being connected, on the semiconductor substrate, to the multiplexing circuit and propagating green light (G);
a third waveguide including the polymer, the third waveguide being connected, on the semiconductor substrate, to the multiplexing circuit and propagating blue light (B);
an output waveguide connected, on the semiconductor substrate, to the multiplexing circuit and located opposite to the first waveguide, the second waveguide, and the third waveguide;
a first mode converter configured to multiplex the green light (G) between the second waveguide and the third waveguide; and
a second mode converter configured to multiplex the blue light (B) between the first waveguide and the third waveguide,
wherein assuming that a propagation loss at a wavelength of the red light (R), a propagation loss at a wavelength of the green light (G), and a propagation loss at a wavelength of the blue light (B) are defined as Rₗₒₛₛ, Gₗₒₛₛ, and Bₗₒₛₛ, respectively, and
a path length for the wavelength of the red light (R), a path length for the wavelength of the green light (G), and a path length for the wavelength of the blue light (B) are defined as L_{R} (cm), L_{G} (cm), and L_{B} (cm), respectively,
a transmittance R_{couple} of the red light (R) and a transmittance G_{couple} of the green light (G) are set to satisfy R_{couple}+Rₗₒₛₛ×L_{R}=G_{couple}+Gₗₒₛₛ×L_{G}=B_{couple}+Bₗₒₛₛ×L_{B}.

4. The optical circuit according to claim 1, further comprising:
a first light source optically connected to the first waveguide;
a second light source optically connected to the second waveguide; and
a third light source optically connected to the third waveguide.

5. The optical circuit according to claim 2, further comprising:
a first light source optically connected to the first waveguide;
a second light source optically connected to the second waveguide; and
a third light source optically connected to the third waveguide.

6. The optical circuit according to claim 3, further comprising:
a first light source optically connected to the first waveguide;
a second light source optically connected to the second waveguide; and
a third light source optically connected to the third waveguide.
